(19) United States
(12) Patent Application Publication
(10) Pub. No.: US 2024/0300416 A1
(43) Pub. Date: Sep. 12, 2024

(54) Collapsible Material Carrier Rack for Pickup Truck that Stores in Truck Bed

(71) Applicant: Eric W Howard, Southern Shores, NC (US)

(72) Inventor: Eric W Howard, Southern Shores, NC (US)

(21) Appl. No.: 18/180,192

(22) Filed: Mar. 8, 2023

(51) Int. Cl. B60R 9/06

(52) U.S. Cl. CPC B60R 9/06; B60R 9/045; B60R 2011/004; B60R 2011/0082

(57) ABSTRACT

A collapsible material carrier rack is described that fits within a pickup truck bed when stowed. A novel use of a three-dimensional mechanism, the Sarrus (or alternate) linkage allows for one-step deployment and stowage of the rack, with the rack top confined to a straight vertical path and other members confined to specific paths. A preferred embodiment is disclosed that moves using a manual crank or a powered rotary driver with removeable pins to lock the rack in the deployed position. The top of the rack retains its shape and remains horizontal during movement, allowing movement while carrying a load. A sliding and repositionable extension of the rack is provided to extend over the truck cab or behind the truck bed. The rack may be fitted with a top surface to present a tonneau cover when stowed. Outsides of the deployed rack may be covered to provide a shelter.

### CROSS REFERENCE TO RELATED APPLICATIONS

Not Applicable

### Statement of federally sponsored research or development (if any)

Not Applicable

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

Not Applicable

### REFERENCE TO A SEQUENCE LISTING, A LARGE TABLE, OR A COMPUTER PROGRAM LISTING APPENDIX SUBMITTED ON A READ-ONLY OPTICAL DISC AND AN INCORPORATION BY REFERENCE OF THE MATERIAL ON THE READ-ONLY OPTICAL DISC

Not Applicable

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Racks are often added to pickup trucks to facilitate hauling of items exceeding the truck bed length, or to increase hauling volume by providing additional mounting space. Recreational equipment such as watercraft, tools such as ladders, or building materials such as lumber are frequently mounted on racks for hauling. When the rack is not in use, it obstructs vison, causes wind noise and drag during vehicle travel, may interfere with parking garage structure or vegetation if driving off-road, is not aesthetically pleasing, and vehicles with visible racks are prohibited from being parked in some communities. Removal and storage of the rack is inconvenient. The collapsible, or retractable, rack solves these problems by allowing easy storage of the rack when not in use. The rack provides full utility when deployed, but can be retracted into the bed of the truck when not in use. The stored rack still allows use of the truck bed volume. A fabric or rigid cover may be installed on the rack top to present a tonneau-style bed cover when stowed, enhancing appearance, aerodynamics, and security of the bed when in the collapsed position. A collapsible truck rack is ideal for the “Weekend Warrior” participating in recreational or hauling activities on the weekend but desiring a normal truck outline and appearance during the workweek.

Racks are often used to transport heavy or bulky (high-volume) loads. Such use presents the problems of loading and unloading the rack in its elevated position. This rack solves this problem by facilitating loading in the stored position, at the level of the truck bed rails, and providing a leveraged or motorized means to lift and lower the load as the rack moves between the stored and deployed positions. Longer loads may require repositioning to prevent collision of the load and the truck cab during movement if the stored load overhangs the truck cab.

Prior Art—There are many truck racks that reconfigure from the deployed position useful for hauling long cargo items, to a stowed position. A few of these can store to present a truck bed cover, or tonneau cover, at the top of the truck bed rails. Patent 9403424, and patent applications 20020149219, 20080129067, 20150232133, and 20190283811, describe racks that deploy from a stored position on top of the truck bed rails, presenting as a tonneau cover. These racks deploy via longitudinal-axis hinges on the bed rails to provide a truck rack and a bed enclosure after pivoting the sides from a horizontal position to a vertical position and installing or deploying transverse members, which may be hinged to the sides. These inventions do not preserve the shape of the deployed top, so all items must be removed from the rack to reposition the assembly into the stored or the deployed positions. Movement between stored and deployed positions is performed manually and requires multiple steps.

Some patented racks have adjustable rack top or shelf heights using various mechanisms, for example, 20080191512 allows the bed cover to slide vertically up and down on four vertical corner stanchions. Patent 3743345 provides a truck bed camper that stores as a tonneau cover and is deployed manually via four telescoping nested square tubes that comprise the corner stanchions. Transverse slots are provided in the top assembly at the mounting of the corner stanchions to facilitate raising one side at a time. Multiple movements are required for these two inventions. Patent application 20040036308 describes a rack that stores as a bed cover at cab top height and raises well over the cab height using four, eight-part, nested (telescoping), motorized screw jacks at the corners to reconfigure from stored to deployed position and back. The powered screw jacks would require precise coordination of movement to avoid distortion of the rack top and binding forces on the screw jacks during movement. Also, the four corner, eight-piece, threaded screw jack will require a significant investment in precision machining, as well as sealing to retain lubricants and to exclude contamination and creation of corrosion products, a small amount of which would lock up the threaded interface. All three of these inventions maintain the rectangular rack top in its shape through movement from stowed to deployed configuration but require many parts to facilitate reconfiguration movement.

All of the sliding or telescoping height racks also suffer from the condition known as “overconstraint”. Three points define a plane, and a three-legged stool is minimally constrained to the floor—it will always sit steady on the floor, despite irregularities in the floor or difference in the stool leg lengths or angles. A four-legged chair or table is overconstrained since there is an additional leg providing a constraint on steady support of loads, and we are all familiar with unsteady four-legged tables. Similarly, a single sliding or telescoping rack stanchion constrains the top to a vertical movement path. Four corner sliding or telescoping rack stanchions simultaneously constrain the top to four vertical movement paths; unless these are precisely aligned, the clearances in, and flexibility of, the sliding or telescoping joints must exceed the misalignment. Overconstraint is another source of distortion and binding in the rack movement mechanism that make sliding and telescoping rack designs problematic.

Patent application 20170335561 describes a collapsible shelter that uses two sets of two hinged panels for the sides. There are six hinges per side and they all have parallel axes. Thus, the sides extend like a bifold door or an accordion. There is no control on hinge movement in the two directions perpendicular to hinge axes, so this invention does not duplicate the disclosed invention. The system would need to be deployed using a labor crew, crane, or other device and is not related to a vehicle.

There are patents for truck racks that reconfigure to facilitate loading and unloading. Patents 3693817, 5904463, 6357991, and 10160371 and patent applications 20060182544, 20120263561, and 20220080897 disclose racks with members that pivot on transverse axes and reconfigure to a ramp to facilitate lowering of cargo items from the front or back of the vehicle. Patent 5884824 and patent applications 20020090285, 20070175936, 20130062378, 20130334267, and 20160023613 all disclose racks that reconfigure into inclined and/or lowered positions off the side of the vehicle facilitating better access to stored cargo items. These inventions enhance access but do not position the load at truck bed rail height in one smooth motion. Patents 4138046 and 7464977, and patent application 20070278810 all describe racks that can be manually lowered one side at a time. These provide no mechanical advantage and would require the load to be inclined during movement risking load movement and loss of control over the cargo load.

### BRIEF SUMMARY OF THE INVENTION

The collapsible truck rack is disclosed that uses a simple three-dimensional mechanism to allow compact storage of a utility rack in the volume of the truck bed. The mechanism provides rapid, simple, one-step deployment and stowage of the rack, with or without a load on the rack. Electric motors, actuators, or fluid cylinders can be used to move the rack and load. A hand crank, powered drill or powered rotary driver can also be used to operate the rack and are shown in the preferred embodiment that is described in detail. Self-deploying safety latches, drop-down tubes enclosing the pinned joints, or spring-loaded pins lock the joints against undesired movement when deployed. Pins and rotation stops are used to secure the rack in the deployed position in the preferred embodiment. A removeable sliding member is inserted into the rack top to provide for extension of the rack over the cab or behind the truck bed in the preferred embodiment. This sliding member stores essentially in the rack when not extended. The rack may have a cover installed so the stowed rack is also a bed (tonneau) cover. Fabric and/or rigid walls may be provided for the rack to provide an enclosure suitable for storage or camping in the deployed position.

### BRIEF DESCRIPTION OF THE SEVERAL VIEWS OF THE DRAWING (IF ANY)

The following description of the disclosed truck rack refer to the preferred embodiment shown in the figures. Other variations of this invention are possible and not excluded from the claims of this patent.

FIG. 1. Shows the collapsible truck rack in the deployed position with the front extension slider in its extended position over the truck cab.

FIG. 2. Shows the collapsible truck rack in the deployed position with the front extension slider retracted into the rack top assembly. When the extension slider is retracted the rack can be moved to the stored position without the rack extension colliding with the truck cab.

FIG. 3 shows the collapsible truck rack between the deployed position and the stored position.

FIG. 4 shows the collapsible truck rack in the stored position.

FIG. 5. Shows an exploded view of the collapsible truck rack in the deployed position with the subassemblies of the truck rack identified.

FIG. 6 shows the lift mechanism.

FIG. 7 shows an alternate construction of the top side panels to display a logo and product name that also provides a mounting surface for carried items such as off-road rescue tools.

### DETAILED DESCRIPTION OF THE INVENTION

The preferred embodiment of the collapsible rack uses a three-dimensional mechanism called the Sarrus linkage to confine the rack top to straight up and down (vertical rectilinear) motion. The Sarrus linkage confines a moving planar structure to rectilinear motion using two or more sets of two panels with the hinge axes of each set of panels perpendicular, or at another angle to each other. Each set of panels consists of two parallel-hinged planar panels. One panel is hinged to a moving planar structure (rack top in the preferred embodiment) with one hinge and shares another hinge with the other panel. The other panel is hinged to the nonmoving base, (the truck in the preferred embodiment) with one hinge and shares another hinge with the other panel. A duplicate set of panels may be provided reflecting the motion of one set of panels.

The preferred embodiment of the collapsible truck rack consists of a set of two side panels that are hinged together with the bottom side panel being hinged to the truck bed and the top side panel being hinged to the rack top panel. All three hinge axes are parallel and extend longitudinally to the truck in the preferred embodiment. A duplicate set of side panels that mirror the movement of the first set of panels is provided to form the opposite side of the collapsible truck rack. The side panels (and their duplicated mirror panels) confine movement of the top frame to a plane perpendicular to the axis of the hinge pins. This plane is the vertical and side to side, or transverse, plane. The perpendicular set of panels in the Saurus linkage are provided by the lift links that are hinged together with the bottom link hinged to the truck bed (via a foundation) and the top panel hinged to the rack top assembly, again with all three hinge axes parallel but extending transversely across the vehicle in the preferred embodiment. The lift links are arranged with the hinge axes perpendicular to the hinge axes of the side panels and confine the top movement to a vertical and longitudinal plane. The top is confined to movement in one plane by the side panels, and is also simultaneously confined to another plane by the lift links. Since the planes are perpendicular, the intersection of these two planes is a vertical line, and the Sarrus linkage confines the top assembly to straight up and down movement. Other members are confined to one predictable path of motion as well.

The preferred embodiment shows the rack with vertical sides. An alternate embodiment of the truck rack would have the sides inclined at an angle as seen in the vertical and transverse plane, with the width of the top of the rack being less than the distance between the bottom of the sides.

Another alternate embodiment would have side assemblies identical to the preferred embodiment, but replace the lift mechanism with two linear actuators extending from the truck bed or base assemblies to the rack top assembly in the vertical and transverse plane at an angle to the truck bed. This set of actuators would have their movement controlled so that the extension of each actuator is of equal value and thus would constrain the top assembly from movement in the transverse direction as does the lift link mechanism in the preferred embodiment. The actuators could use ball screws, screw drives, fluid cylinders, electric motor and gear assemblies or other methods.

The hinges in the side assemblies use rotation stops, geometric features on the hinge joints to confine the hinged joint rotation to angles needed to move through the stowed and deployed positions. Travel past the deployed position (relative to the stowed position) when carrying cargo items would adversely affect the structural load path from the weight of carried cargo items and is not desired. It is also not desired for the deployed-position joints to be able to move towards the stowed position when carrying cargo items. Locks on some or all of the hinged side joints are needed to prevent this movement. Rotation stops and removable pins are used in the preferred embodiment to prevent undesired movement of the side hinge joints. These pins could be replaced by spring-loaded pins on the inside of the frame members, drop (using gravity to move into position) or spring-loaded tubes on the outside of the joints, latches or pawl locks, or electrically-operated locks in alternate embodiments. Also, springs to bias the hinges to the stored position may be added to eliminate the need to move hinges away from the fully-deployed position prior to lowering the rack top, and use of spring-biased hinges is recognized as an alternate embodiment.

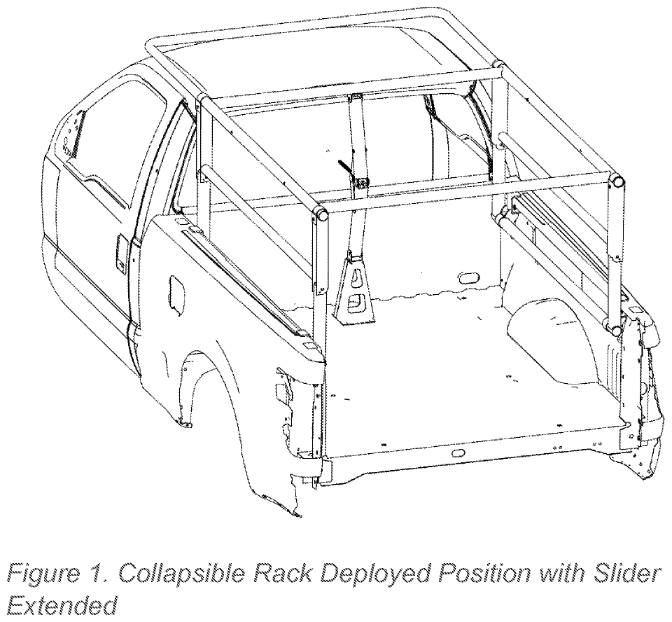

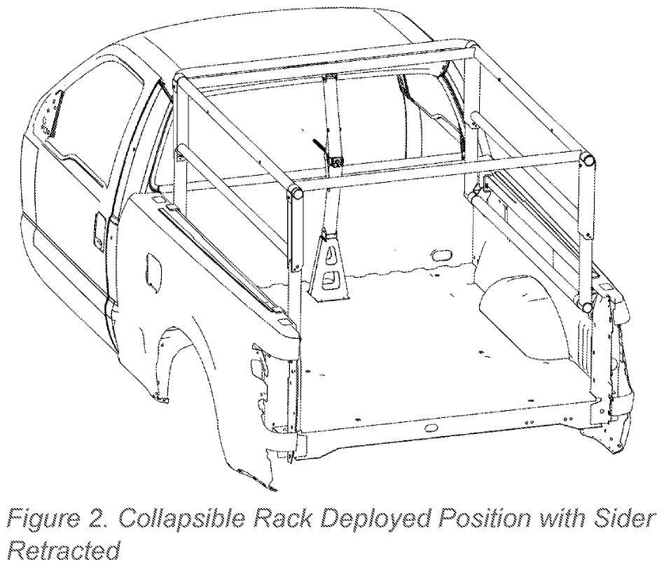

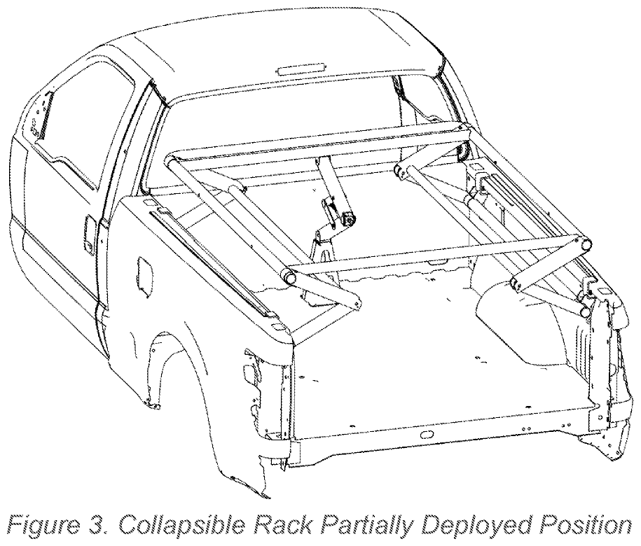

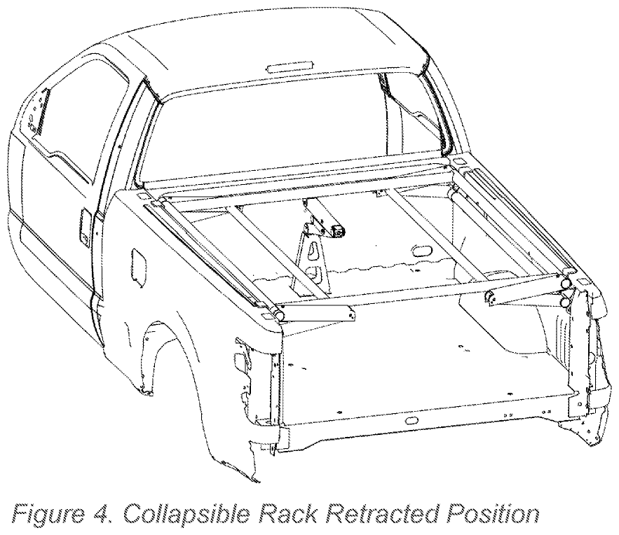

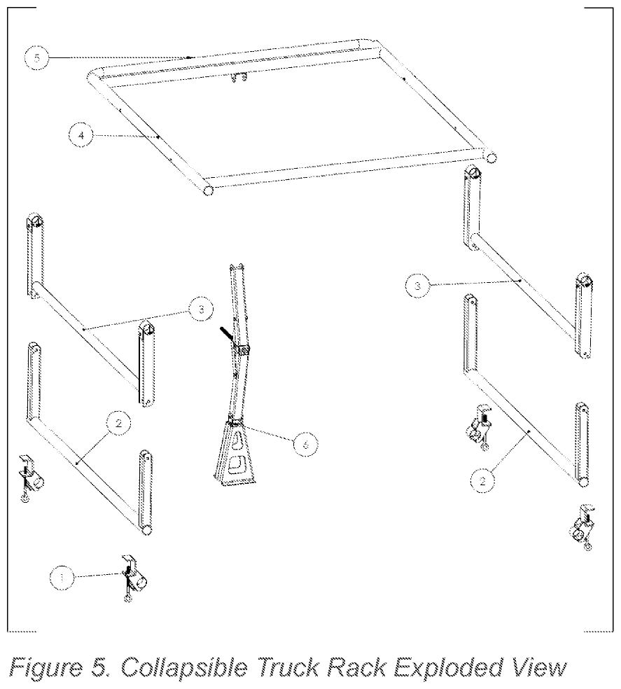

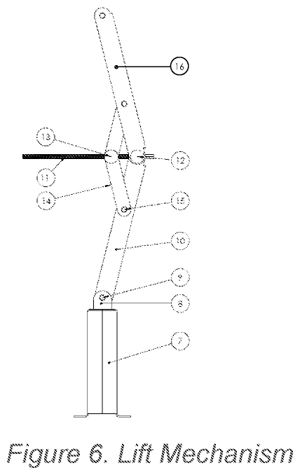

The following is a description of the figures that show the preferred embodiment. FIG. 1. Shows the collapsible truck rack in the deployed position with the front extension slider in its extended position over the truck cab. FIG. 2. Shows the collapsible truck rack in the deployed position with the front extension slider retracted into the rack top assembly. When the extension slider is retracted the rack can be moved to the stored position without the rack extension colliding with the truck cab. FIG. 3 shows the collapsible truck rack between the deployed position and the stored position. This figure shows how the rack sides fold to its compact storage configuration. FIG. 4 shows the collapsible truck rack in the stored position. FIG. 5. Shows an exploded view of the collapsible truck rack in the deployed position with the subassemblies of the truck rack identified. 1 Is the base assembly. The four base assemblies attach the collapsible truck rack to the top of the truck bed rail using screw eyes to clamp the base to the truck bed rail. Each base assembly provides a semi-circular member and a screwed-on band clamp that encircles the lower side frame round tube, 2, and forms a hinge between the base and the lower side frame assembly. 2. 1 The base assemblies are made from a U-shaped frame cut from a square steel tube and welded steel plates along with the screw eye and screwed-on band clamp. 2 The lower side frame assembly has two holes on the top of the frame that are joined with holes on 3, the upper side frame assembly using pins to form another hinge. The top of 3, the upper side frame assembly, has two semi-circular ends and screwed-on band clamps that encircle the top frame round tube, and form a hinge between the upper side frame assembly and 4, the top frame assembly. Both side frames are made from tubular steel with the vertical components welded to the tubes. The lower frame has square steel tubes as the vertical component and the upper side frames use a formed sheet metal U-channel. Inserted into the ends of the top frame assembly is 5, a U-shaped top extension made from bent tubular steel. This top extension is used to provide a support for material over the truck cab. The top extension can be removed from the top and inserted into the back of the top frame assembly as needed. The top extension is secured to the top assembly using steel clevis pins. Opposite the two side frames (lower and upper) is another set of side frames, a mirror image of the first set of side frames. This third system of frames mirrors the movement of the first panel system and provides a structural load path to bear rack loads. Rotational stops and pins to stop hinge movement are provided on the vertical (taken in the deployed position) parts of the side frames. Between the side frames, located at the front of the assembly (relative to the truck on which the rack is mounted) is 6, the lift mechanism. The lift mechanism is shown in greater detail in FIG. 6. The lift mechanism is attached to 7, a foundation that is attached to the truck bed and raises the bottom mounting point of the lift mechanism. The foundation is formed sheet steel with the front and back halves welded together. The top of the foundation has a clevis 8, welded to it, that is hinged via a pin 9 to the lower lift link 10. This clevis and the clevis on the top of the lift mechanism are formed from sheet steel. The jack screw 11 connects two jack nuts, one not threaded 12 but with a hole sized to clear the threads of the jack screw and one threaded 13. The jack screw has its end formed into a hexagonal prism used to drive the screw. The screw moves the threaded jack nut closer or further away as it is turned changing the distance between the jack nuts and raising or lowering the top frame assembly. The jack nut with the clearance hole 12 serves as a pin connecting 15 the upper and 10 lower lift links. The threaded jack nut 13 also serves as a pin to connect the four identical flat links 14 to each other and to the jack screw. The other end of the flat links 14 are attached using pins to form hinges on 10 the lower lift link, and 15 the upper lift link. The upper lift link is pinned to the top fame assembly via a welded clevis that is part of the top frame assembly. Thus, there are three parallel hinges in the assembly of the upper and lower links that connect the truck bed to the rack top. The link hinge axes are aligned in the transverse direction. The lift links and flat links are formed from sheet steel. The jack screw and jack nuts are machined from steel bar. Clevis pins are machined from steel bar as well.

The rack sides and the two large links of the preferred embodiment lift mechanism confine the rack top to a straight up and down path. The jack screw and flat links provide a simple method for deploying and stowing the rack, even while lifting and lowering loads. The described mechanism allows the entire rack structure to be deployed and stowed in one movement driven by the lift mechanism. The top of the rack does not change shape and remains horizontal during movement, so the rack may be moved from its stored and deployed positions (and from deployed to stored position) while a load is attached, provided the load does not overhang and interfere with the truck cab.

The lift mechanism can be operated using levers, worm drives, ball screws, gear drives, fluid cylinders (hydraulic or pneumatic) or a scissors-jack like system added to the central system of the lift links as shown in the preferred embodiment. This jack provides the force to deploy and store the mechanism in the preferred embodiment. FIG. 6 shows a jack screw that can be operated using a manual crank or a portable variable-speed driver/drill as the preferred embodiment. The system could also be driven using actuators driving the rack side members instead of driving the lift links. The jack mechanism or alternate actuators could be powered by electric motors (with or without gears), solenoids, or pumps or compressors and fluid power.

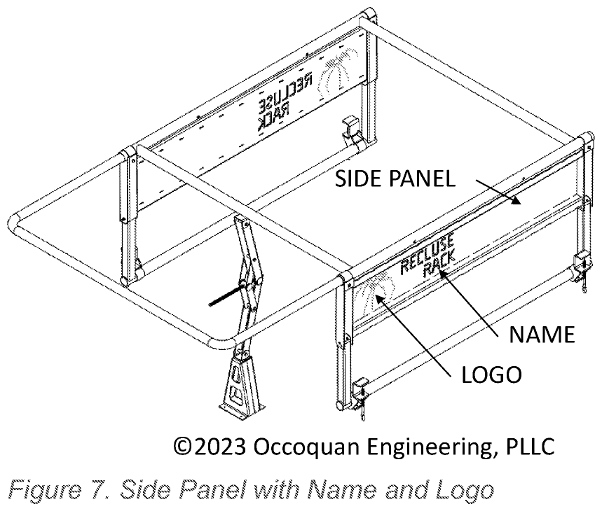

The side frames shown may be replaced with panels allowing for display of product logo and name. The panels may also provide mounting points for material to be transported such as tools used for off-road travel and camping, for example jack, axe, shovel, rescue ramps, fuel containers, water containers, etc. A preferred embodiment of the panel side is shown in FIG. 7.

1. I claim use of the Sarrus linkage move a collapsible rack structure to lift and carry cargo items.
I claim use of one set of moving panels/links in the Sarrus linkage to drive movement of the Sarrus linkage in a rack.
I claim use of two hinged rack side assemblies with parallel hinge axes, one hinge connecting one panel to the base (which is immovably secured to the installation site), a second hinge connecting the two panels together, and a third hinge connecting the top panel to the rack top assembly, a similar set of two hinged side panel assemblies with geometry mirrored about a vertical and longitudinal plane central to the rack, and two actuators extending from the installation site to the rack top assembly in the vertical and transverse plane at an angle to the ground plane with the coordinated actuator movement constraining transverse top movement to provide vertical rectilinear movement of the top assembly.
I claim a moveable cover and/or an erectable shelter or storage area under the rack top by use of enclosing panels, either rigid, flexible (such as fabric) or a combination of these using the Sarrus linkage or alternate mechanism described in the preceding claim.
I claim use of a panel in place of the tube and link frames as part of the Sarrus linkage to display product name, logo or other trademarks, and to store carried items mounted via holes and attachment devices such as threaded fasteners, brackets or straps.
